(19) United States
(12) Patent Application Publication
(10) Pub. No.: US 2005/0287961 A1
(43) Pub. Date: Dec. 29, 2005

(54) Vibrator for a mobile phone

(76) Inventor: Yu-Ying Chiou, Tyan Wei Hsiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/876,882

(22) Filed: Jun. 25, 2004

(51) Int. Cl. H04Q 7/20

(52) U.S. Cl. 455/90.3

(57) ABSTRACT

A vibrator for a mobile phone has a housing assembly, a first magnet winding, a first spring and a slider. The housing assembly has a longitudinal housing and a cap. The longitudinal housing has an opening and a longitudinal chamber. The first magnet winding is wrapped around the longitudinal housing. The first spring is attached to the cap inside the longitudinal housing. The slider is attached to the first spring and is mounted slidably inside the longitudinal housing. The vibrator is mounted to a mobile phone and vibrates inside the mobile phone with the first magnet winding being electrified intermittently.

### BACKGROUND OF THE INVENTION

1. Field of the Invention

The present invention relates to a vibrator, and more particularly to a vibrator for a mobile phone.

2. Description of Related Art

Mobile phones have become enormously popular in recent years and are considered as essential as a wristwatch. A mobile phone generally has an audio alarm that can sound when the mobile phone receives an incoming call. Many mobile phones also have a vibrator by which the user can be notified of an incoming call in a relatively silent way such that the surrounding environment is not disturbed by unsuitable noise. Alternatively, the vibrator can be used in combination with the audio alarm circuit in a very noisy environment where the only the vibrator may be noticed. A conventional vibrator in accordance with the prior art has a motor. The motor has a bearing, a spindle and an eccentric weight. The spindle is mounted rotatably to the bearing inside the motor, is rotated by the motor, extends through the motor and has a distal end. The eccentric weight is mounted at one end of the spindle. The conventional vibrator is connected to a circuit board of a mobile phone and is driven by signals from the circuit board to vibrate when the mobile phone receives an incoming call.

To facilitate the convenience of carrying a mobile phone, mobile phones are sized increasingly smaller. Additional, more and more functions such as picturing photos, playing video games and playing music are integrated into a mobile phone. Quantity of electrical components in a mobile are increased so the components have to be sized smaller. However, the motor of the conventional vibrator is intricate and has a high cost. In fact, it is found that the smaller the motor is sized, the higher cost is of the motor.

It is predictable that mobile phone manufacturers will invest significant amounts to achieve market dominance through optimum compactness of their phones. The size of the conventional vibrator will be reduced to correspond to the mobile phone sized smaller. Manufacturers have to recoup those investments by reflecting the costs in the price of the retailed phones. The cost of the mobile phone will be increased.

To overcome the shortcomings, the present invention provides a vibrator for a mobile phone to mitigate or obviate the aforementioned problems.

### SUMMARY OF THE INVENTION

The main objective of the invention is to provide a vibrator for a mobile phone that has a simple structure, is made easily and has a cost lower than the conventional vibrator described above.

A vibrator for a mobile phone in accordance with the present invention comprises a housing assembly, a first magnet winding, a first spring and a slider.

The housing assembly has a longitudinal housing and a cap. The longitudinal housing has an opening and a longitudinal room. The first magnet winding is wrapped to the longitudinal housing. The first spring is attached to the cap inside the longitudinal housing. The slider is attached to the first spring and is mounted slidably inside the longitudinal housing.

Other objects, advantages and novel features of the invention will become more apparent from the following detailed description when taken in conjunction with the accompanying drawings.

### BRIEF DESCRIPTION OF THE DRAWINGS

FIG. 1 is a side view in partial section of a mobile phone with a vibrator for a mobile phone in a non-actuated status, in accordance with the present invention;

FIG. 2 is an operational view of the mobile phone with the vibrator in FIG. 1 showing that the first magnet winding is in an actuated status;

FIG. 3 is a side view in partial section of the mobile phone with another embodiment of a vibrator for a mobile phone in accordance with the present invention;

FIG. 4 is an optional view in partial section of the mobile with the vibrator in FIG. 3 showing that the first magnet winding is in an actuated status and the second magnet winding is in a non-actuated status; and

FIG. 5 is an optional view in partial section of the mobile with the vibrator in FIG. 3 showing that the second magnet winding is in an actuated status and the first magnet winding is in a non-actuated status.

### DETAILED DESCRIPTION OF PREFERRED EMBODIMENT

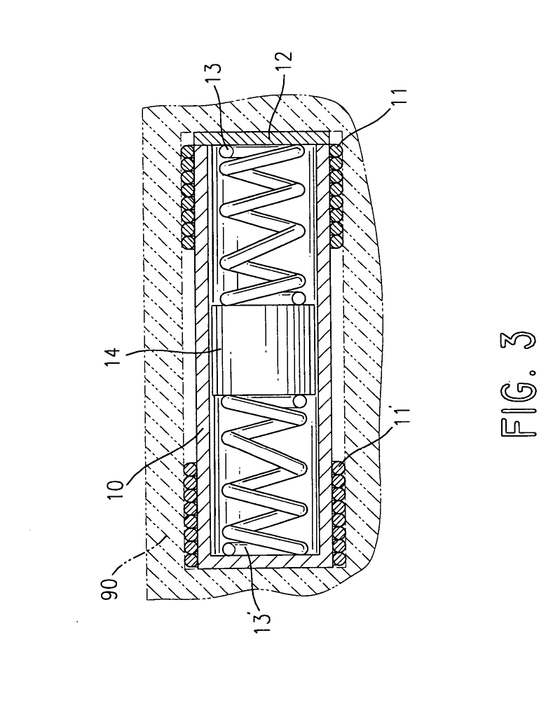

With reference to FIG. 3, a mobile phone (90) has a circuit board (not shown), wherein the detail structure of the circuit board is not an essential feature of the present invention, is conventional and not further described. A vibrator for a mobile phone in accordance with the present invention is mounted inside a mobile phone (90) and is connected electrically to the circuit board.

The vibrator for a mobile phone in accordance with the present invention comprises a housing assembly, a first magnet winding (11), a first spring (13), a slider (14), an optional second magnet (11′) winding and an optional second spring (13′).

The housing assembly has a longitudinal housing (10) and a cap (12). The longitudinal housing (10) has an outer surface, a distal end, a proximal end, an opening, a longitudinal chamber and a distal inner surface. The opening is defined at the proximal end. The longitudinal chamber is defined inside the longitudinal housing (10) and is communicated with the opening. The distal inner surface corresponds to the distal end. The cap (12) is attached to the proximal end of the longitudinal housing (10) and has an inner surface facing the longitudinal chamber.

The first magnet winding (11) is wrapped around the outer surface of the longitudinal housing (10) close to the opening. The first magnet winding (11) is connected electrically to the circuit board of the mobile phone (90), and is electrified intermittently by the circuit board when the mobile phone (90) receives an incoming call.

The first spring is attached to the inner surface of the cap (12) and has a distal end and proximal end. The proximal end of the first spring (13) is connected to the inner surface of the cap (12).

The slider (14) is made of metal and is attached to the distal end of the first spring (13) and is mounted slidably inside the longitudinal room of the longitudinal housing (10).

The optional second magnet winding (11′) is wrapped around the outer surface close to the distal end of the longitudinal housing (10). The optional second magnet winding (11′) is connected electrically to the circuit board of the mobile phone (90), and is electrified intermittently by the circuit board when the mobile phone (90) receives an incoming call.

The optional second spring (13′) is attached to the distal inner surface inside the longitudinal room of the longitudinal housing (10) and has a proximal end and a distal end. The proximal end of the optional second spring (13′) is connected to the distal inner surface of the longitudinal housing (10). The distal end of the optional second spring (13′) abuts against the slider (14).

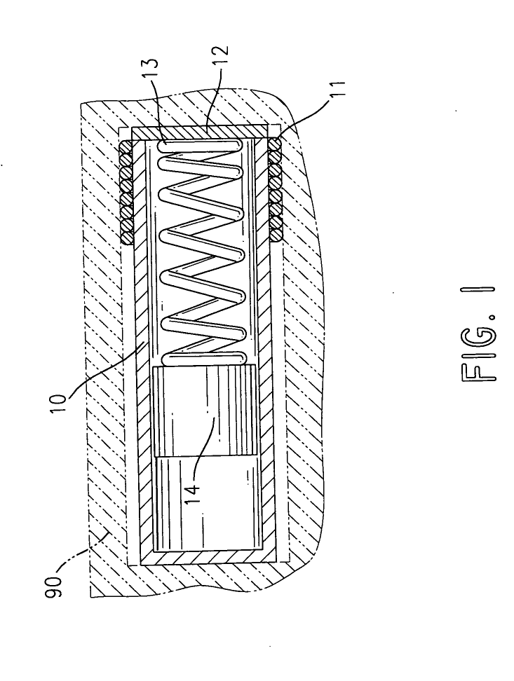

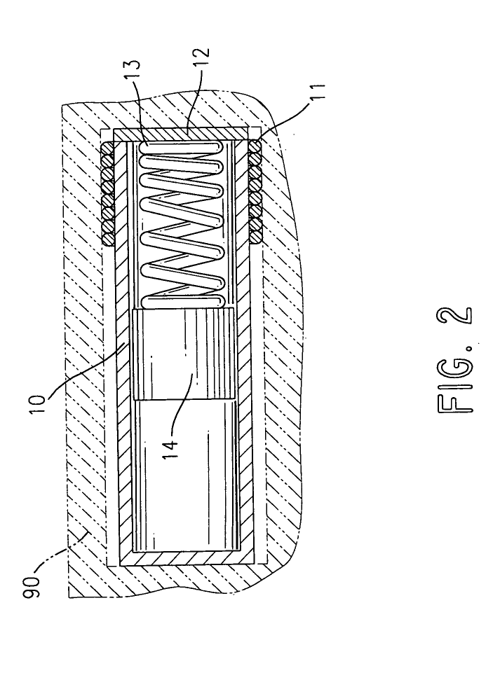

With reference to FIGS. 1 and 2, an embodiment of a vibrator for a mobile phone in accordance with the present invention operates without having the optional second magnet winding (11′) and the optional second spring (13′). When the mobile phone receives an incoming call, the first magnet winding (11) is electrified intermittently by the circuit board. When the first magnet winding (11) is not electrified, the slider (14) is located at an original position, as shown in FIG. 1. While the first magnet winding (11) is being electrified, the first magnet winding (11) generates a magnetic force in a direction along the longitudinal housing (10) to attract the slider (14). The slider (14) is attracted to press against the first spring (13) and slides toward the first magnet winding (11), as shown in FIG. 1. While the first magnet winding (11) is being electrified again, the slider (14) is pushed by stored energy of the first spring (13). The intermittent electrification of the first magnet winding (11) results in that the slider (14) slides back and forth inside the longitudinal room and makes the mobile phone (90) vibrate.

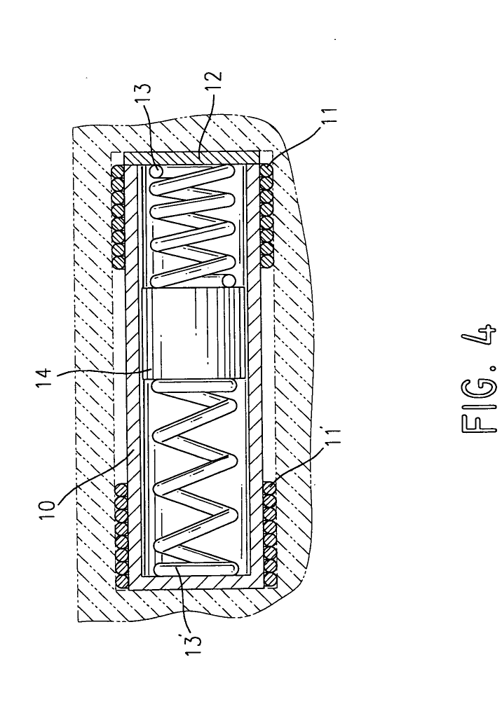

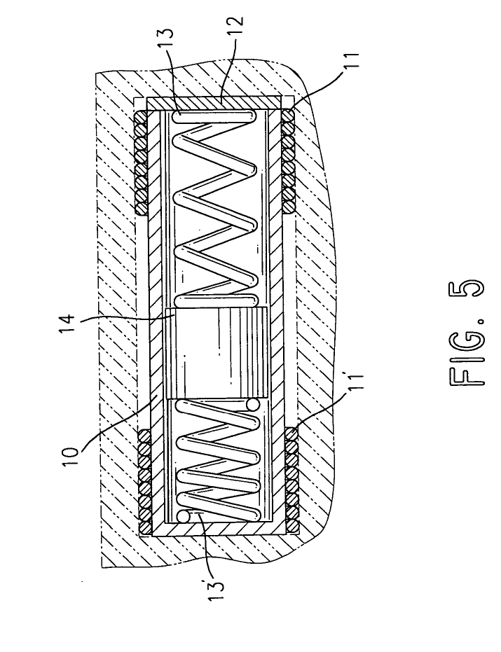

With reference to FIGS. 3 to 5, another embodiment of a vibrator for a mobile phone in accordance with the present invention includes the optional second magnet winding (11′) and the optional second spring (13′) and functions in a manner similar to the other embodiments. When the mobile phone (90) receives an incoming call, the first and second magnet winding (11, 11′) are electrified alternately and intermittently by the circuit board. When the first magnet winding (11) is being electrified and the second magnet winding (11′) is not electrified, the first magnet winding (11) generates a magnetic force in a direction along the longitudinal housing (10) to attract the slider (14). The slider (14) is attracted to press against the first spring (13) and slides toward the first magnet winding (11), as shown in FIG. 4. When the second magnet winding (11′) is being electrified and the second magnet winding (11) is not electrified, the second magnet winding (11) generates a magnetic force in a direction along the longitudinal housing (10) to attract the slider (14). The slider (14) is attracted by the magnetic force of the second magnet winding (11′) and simultaneously the first spring pushes the slider (14) toward the second magnet winding (13), as shown in FIG. 5. The second embodiment of the vibrator for a mobile phone in accordance with present invention vibrates more powerfully than the first embodiment of the vibrator for a mobile phone in accordance with present invention.

The vibrator for a mobile phone in accordance with the present invention has a simple structure, is made easily, has a cost lower than the conventional vibrator described above and can substitute for the conventional vibrator.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A vibrator for a mobile phone comprising:
a housing assembly having
a longitudinal housing having
an outer surface;
a distal end;
a proximal end;
an opening defined at the proximal end;
a longitudinal chamber defined inside the longitudinal housing and communicated with the opening; and
a distal inner surface corresponding to the distal end;
a cap attached to the proximal end of the longitudinal housing and having an inner surface facing the longitudinal room;
a first magnet winding wrapped around the outer surface of the longitudinal housing close to the opening;
a first spring attached to the inner surface of the cap and having
a distal end; and
a proximal end connected to the inner surface of the cap; and
a slider made of metal and attached to the distal end of the first spring and mounted slidably inside the longitudinal chamber of the longitudinal housing.

2. The vibrator for a mobile phone as claimed in claim 1 further comprising:
a second magnet winding wrapped around the outer surface close to the distal end of the longitudinal housing; and
a second spring attached to the distal inner surface inside the longitudinal chamber of the longitudinal housing and having
a proximal end connected to the distal inner surface of the longitudinal housing; and
a distal end abutting against the slider.
